(19) United States
(12) Patent Application Publication
(10) Pub. No.: US 2019/0176176 A1
(43) Pub. Date: Jun. 13, 2019

(54) IMPROVEMENTS IN AND RELATING TO GARMENT REFRESHMENT

(71) Applicant: Conopco, Inc. d/b/a UNILEVER, Englewood Cliffs, NJ (US)

(72) Inventors: Geraint Paul ROBERTS, Ellesmere Port (GB); Rachel Louise TOOMES, Wirral (GB)

(73) Assignee: Conopco, Inc. d/b/a UNILEVER, Englewood Cliffs, NJ (US)

(21) Appl. No.: 16/321,930

(22) PCT Filed: Jul. 21, 2017
(86) PCT No.: PCT/EP2017/068512

§ 371 Date: Jan. 30, 2019

(30) Foreign Application Priority Data
Aug. 5, 2016 (EP) 16183128.4

(51) Int. Cl. B05B 11/00

(52) U.S. Cl. CPC B05B 11/30; B05B 11/0037; B05B 11/0032

(57) ABSTRACT

The present invention is concerned with a garment refresh product (1) comprising: a garment refreshing composition (12); and a hand-held spray device which is manually operable to produce a spray of said composition in the form of a fine aerosol (29); said composition (12) comprising at least one of: an anti-malodour agent, an anti-wrinkle agent, and a perfume; and said spray device comprising a reservoir (2) containing said composition (12) and a spray mechanism (15) housed within a shroud (3) which is substantially aligned with a longitudinal axis (8) of said reservoir (2); said spray mechanism (15) being manually operable to discharge a dose of said composition (12) from the product (1) in the form of a fine aerosol (29) and in a spray-direction (5) which is substantially orthogonal to said longitudinal axis (8) of the reservoir (2). Suitably the spray mechanism (15) comprises a nozzle (23) located within said shroud (3), the nozzle (23) having a discharge orifice (25) which is configured to produce said fine aerosol (29) in a spray having a cone angle (A) in the range of 55 to 80 degrees and/or a spray which comprises droplets having an average diameter in the range of 20 to 200 μm.

The present invention relates to garment refreshment.

Refresh products have been proposed previously, for example “air fresheners” or carpet and upholstery refreshers, and generally comprise a hand-operable spray bottle containing a liquid composition which may include an anti-malodour compound and/or a perfume. In such products spray bottles are typically used to direct a spray of the composition onto a surface or into the air in order to neutralise and/or mask unpleasant odours.

It has been proposed to use such products in trigger-operated “gun” type bottles to refresh items of clothing in order to prolong their acceptable use between washes.

### SUMMARY OF THE INVENTION

The applicant has identified some perceived problems and shortcomings associated with conventional refresh products of the type discussed above.

One problem which can arise from conventional refresh products of the type described above is that they often do not generate a sufficiently fine spray of liquid to avoid the creation of unsightly spots on a garment when the spray settles on the garment. In some cases this can cause staining, which will be unacceptable to a user of the product. Even in the absence of staining, the creation of localised wet patches will be unattractive and inconvenient for the user, especially if the garment is to be worn immediately. Of course, this is not a problem for products intended for carpet or upholstery use, for example.

In some cases, it is thought that even if the liquid composition itself were to be prepared so as not to create an actual stain on contact with the fabric of a garment, the mere perception by some users of a relatively wet spray containing large liquid droplets can create concern on the part of the user and hence discourage frequent use of such products to refresh garments between washes.

It has also been identified that sometimes even the actual shape or configuration of a conventional spray bottle, which many potential consumers might generally associate with relatively wet spray products such as household cleaning products or the like, can add to a user's worries about the potential for staining, and hence discourage their use of conventional fabric refresh products.

Whilst so-called “aerosol spray” products of a type requiring a pressurised propellant may address some of the above-mentioned issues, they are generally considered bad for the environment nowadays, and have hence become somewhat unpopular with consumers.

It is therefore an object of the present invention to provide an improved garment refresh product. It is another object of the invention to provide an improved fabric refresh spray. And it is a still further object of the invention to provide an improved method of creating a garment refresh spray.

In a first aspect the present invention provides a garment refresh product comprising: a garment refreshing composition; and a hand-held spray device which is manually operable to produce a spray of said composition in the form of a fine aerosol; said composition comprising at least one of: an anti-malodour agent, an anti-wrinkle agent, and a perfume; and said spray device comprising a reservoir containing said composition and a spray mechanism.

In the proposals described herein, one or more of: the configuration of the spray mechanism; the provision of specific spray characteristics; and the garment refreshing composition is adapted so as to maximise the achievement of garment refresh events by the user.

In one proposal, the spray device is adapted for more effective and convenient operation by the provision of a shroud surrounding the spray mechanism, the shroud being aligned with the reservoir of the device.

In another proposal, the spray device is adapted for more effective use by the provision of a shroud surrounding the spray mechanism, wherein the shroud is elongate and the spray direction of the device is substantially orthogonal to a longitudinal axis of the shroud.

In another proposal, the spray device is adapted for more effective use by the provision of spray mechanism having a discharge orifice which is configured to produce a fine aerosol spray having a comparatively large cone angle, suitably in the range of 55 to 80 degrees.

In another proposal, the spray device is adapted for more effective use by the provision of spray mechanism which is configured to produce a fine aerosol having a small average droplet size, suitably in the range of 20 to 200 μm.

Each of these proposals addresses the above mentioned problems, and combinations of these proposals are particularly effective at achieving the desired outcomes including consumer perception and satisfaction with the product.

In this connection, each and every combination of the proposals is hereby disclosed.

By providing a spray device that is adapted to consumer preferences and tailored to garment refresh, use of the garment refreshing composition will increase, and preferably become habitual, thereby reducing the frequency of washes. And so a reduction in the use of water, cleaning actives and energy can be achieved. This is a valuable contribution especially in view of the large volumes of water used in washing machines.

Furthermore, an improved “garment refresh effect” is achieved per unit dose of garment refreshing composition. In turn this may permit use of less “garment refresh actives” such as anti-malodour, anti-wrinkle and perfume.

### DETAILED DESCRIPTION OF THE INVENTION

### Shroud

Suitably the spray mechanism is housed within a shroud. Advantageously, said shroud may have a longitudinal axis which is substantially aligned with the longitudinal axis of said reservoir.

Suitably said spray mechanism is manually operable to discharge a dose of said composition from the product in the form of a fine aerosol.

Suitably the spray has a spray-direction which is substantially orthogonal to said longitudinal axis of the reservoir.

Suitably the shroud is elongate and the spray has a spray-direction which is substantially orthogonal to a longitudinal axis of the shroud.

Conveniently, said spray mechanism may comprise a nozzle located within said shroud, the nozzle having a discharge orifice. Thus, the nozzle does not protrude from shroud. This can assist in improving user acceptance, for example by avoiding association with “gun” type spray devices that typically produce a jet-type output with associated staining/intensive deposition. It may also serve to prevent snagging of the device on garments. It may also assist in providing a consistent spray over repeated uses and/or within a given spray event, because the discharge orifice of the nozzle is shielded/protected by the shroud.

Optionally, said shroud is substantially cylindrical in form and is mounted to said reservoir so as to extend upwardly therefrom.

Suitably the diameter of the shroud is substantially constant along its length. Suitably the diameter of the container is substantially constant along its length. Suitably the diameter of the shroud and the container is substantially constant along their respective lengths. Suitably the diameter of the shroud and the diameter of the container are substantially the same.

Suitably, and in contrast to conventional refresh spray products, the container does not include a necked down/neck portion.

Suitably the cross-section shape of the shroud along its longitudinal axis is substantially constant. For example, the shroud may have a circular cross-section along its length.

Suitably the shroud is substantially radially symmetrical along at least a part of, suitably substantially all of, its longitudinal axis. For example, the shroud may have a circular cross-section along its length.

The coaxial arrangement of shroud and reservoir assists in the holding and handling of the spray device, which in turn facilitates smooth operation of the actuator and consistency between consecutive operations. The favourable ergonomics can also assist in providing a more comfortable extended use of the device, for example where garment refreshing composition is being applied to a large garment such as a winter coat, or multiple garments.

The coaxial shroud, and especially the elongate and/or generally cylindrical shape, assists in providing a device that is comparatively insensitive as to the location at which it can be held by the user. Likewise the orientation in which the user's hand holds/grips the device. For example, the user can hold the device comfortably with their palm or thumb behind the outlet aperture of the shroud. In contrast, “gun” type spray devices oblige a user to hold the device in one specific orientation because of the “necked” shape of the container and the shape of the spray mechanism.

The coaxial shroud also assists in providing a centre of gravity to the device that is located on the (common) longitudinal axis, which in turn assists with comfortable, consistent and extended use. Indeed, the centre of gravity may remain on this axis independently of the fill level of the container.

The coaxial shroud also permits a range of orientations of the spray mechanism with respect to the reservoir/container. This in turn permits greater flexibility and tolerance in the joining/coupling of the container to the spray mechanism. This can be a particular advantage where the container is to be detached from time to time, for example to refill the container, or where a replaceable reservoir is used.

The reservoir (strictly, the container defining the reservoir) can serve as part of the “grip” which the user holds whilst manipulating and operating the device.

Conveniently, said shroud may be removable, in combination with said spray mechanism therein, from said reservoir.

Advantageously, said shroud and said reservoir may be configured for releasable engagement with one another.

Optionally, said shroud and said reservoir are threadedly engaged.

Alternatively, said shroud and said reservoir may be engaged with one another as an interference fit.

According to a further aspect related to the first aspect of the present invention, there is provided a garment refresh product comprising: a garment refreshing composition; and a hand-held spray device which is manually operable to produce a spray of said composition in the form of a fine aerosol; said composition comprising at least one of: an anti-malodour agent, an anti-wrinkle agent, and a perfume; and said spray device comprising a reservoir containing said composition and a spray mechanism housed within a shroud which is substantially aligned with a longitudinal axis of said reservoir; said spray mechanism being manually operable to discharge a dose of said composition from the product in the form of a fine aerosol and in a spray-direction which is substantially orthogonal to said longitudinal axis of the reservoir.

Spray Characteristics

Suitably the spray mechanism comprises a nozzle and is operable to discharge a dose of said composition from the nozzle in the form of a fine aerosol.

Suitably the nozzle has a discharge orifice which is configured to produce said fine aerosol in a spray having a wide cone angle that facilitates even application of the composition to a garment.

Suitably the spray has a cone angle of at least 50 degrees, preferably at least 55 degrees, more preferably at least 60 degrees.

Suitably the spray has a cone angle of no more than 90 degrees, preferably no more than 85 degrees, more preferably no more than 80 degrees.

Suitable cone angles are selected from the range of 50 to 90 degrees, suitably 55 to 80 degrees, suitably 60 to 80 degrees.

Advantageously, said discharge orifice may be configured to produce said fine aerosol in a substantially circular spray pattern.

As discussed below, it is proposed that said composition may be provided in the form of a liquid, such that the fine aerosol produced will suitably take the form of a fine mist. Droplet size is discussed below.

By configuring the spray mechanism to deliver sprays with the above mentioned characteristics it is possible to maximise the proportion of the sprayed garment refreshing composition that is deposited on the garment. Suitably at least 50% by weight of the dose is captured on the garment, suitably at least 60 wt %, suitably at least 70 wt %, suitably at least 80 wt %; and suitably at least 90 wt %.

According to a further aspect related to the first aspect of the present invention, there is provided a fabric refresh product comprising: a garment refreshing composition; and a hand-held spray device which is manually operable to produce a spray of said composition in the form of a fine aerosol; said composition comprising at least one of: an anti-malodour agent, an anti-wrinkle agent, and a perfume; and said spray device comprising a reservoir containing said composition and a spray mechanism; said spray mechanism comprising a nozzle and being manually operable to discharge a dose of said composition from the nozzle in the form of a fine aerosol, wherein said nozzle has a discharge orifice which is configured to produce said fine aerosol in a spray having a cone angle in the range of 55 to 80 degrees.

Dose

Conveniently, the garment refreshing composition is provided as a liquid, and said spray mechanism is operable to discharge a dose of at least 0.1 ml, preferably at least 0.2 ml, more preferably at least 0.25 ml, more preferably at least 0.3 ml, more preferably at least 0.35 ml, more preferably at least 0.35 ml, more preferably at least 0.4 ml, more preferably at least 0.45 ml, and most preferably at least 0.5 ml.

Suitably the dose is no more than 2 ml, preferably no more than 1.8 ml, preferably no more than 1.6 ml, more preferably no more than 1.5 ml, more preferably no more than 1.4 ml, more preferably no more than 1.3 ml, and most preferably no more than 1.2 ml.

Suitably the dose is between 0.1 and 2 ml of said liquid garment refreshing composition, preferably between 0.2 and 1.8 ml, more preferably 0.25 to 1.6 ml, more preferably 0.25 to 1.5 ml, and most preferably 0.25 to 1.2 ml.

These doses have been found to be particularly effective at achieving the desired garment refresh effect (for example anti-wrinkle) without unsightly and wasteful large droplet formation.

According to a further aspect related to the first aspect of the present invention, there is provided a garment refresh product comprising: a garment refreshing composition; and a hand-held spray device which is manually operable to produce a spray of said composition in the form of a fine aerosol; said composition comprising at least one of: an anti-malodour agent, an anti-wrinkle agent, and a perfume; and said spray device comprising a reservoir containing said composition and a spray mechanism housed within a shroud which is substantially aligned with a longitudinal axis of said reservoir; said spray mechanism being manually operable to discharge a dose of said composition from the product in the form of a fine aerosol and in a spray-direction which is substantially orthogonal to said longitudinal axis of the reservoir, wherein said dose is between 0.5 and 1.5 ml of the composition.

Droplet Size

Suitably the spray comprises droplets having an average diameter of no more than 250 μm, suitably no more than 200 μm, suitably no more than 150 μm, suitably no more than 125 μm, suitably no more than 100 μm.

Suitably the spray comprises droplets having an average diameter of at least 5 μm, suitably at least 10 μm, suitably at least 20 μm, suitably at least 30 μm, suitably at least 40 μm, suitably at least 50 μm.

Suitably the spray comprises droplets having an average diameter in the range of 20 to 200 μm, suitably 40 to 150 μm, suitably 40 to 125 μm.

By providing an improved aerosol (especially a fine mist) there is more efficient use of the garment refreshing composition. Not only can a greater proportion of the sprayed garment refreshing composition be deposited on a fabric but the effectiveness of the deposited garment refreshing composition can be improved. In particular, the droplet dimensions in the ranges disclosed herein can achieve a comparatively even or homogenous distribution of active on the garment, which in turn optimises the garment refresh effect.

In embodiments, the spray devices can apply a significant quantity of garment refreshing composition to a large area of garment with even coverage and no visible wetting or marking. This is particularly advantageous for larger garments such as coats, jackets and other outer-garments.

Measurement of droplet size is discussed below in conjunction with the experiments conducted by the inventors.

According to a further aspect related to the first aspect of the present invention, there is provided a garment refresh product comprising: a garment refreshing composition; and a hand-held spray device which is manually operable to produce a spray of said composition in the form of a fine aerosol; said composition comprising at least one of: an anti-malodour agent, an anti-wrinkle agent, and a perfume; and said spray device comprising a reservoir containing said composition and a spray mechanism housed within a shroud which is substantially aligned with a longitudinal axis of said reservoir; said spray mechanism being manually operable to discharge a dose of said composition from the product in the form of a fine aerosol and in a spray-direction which is substantially orthogonal to said longitudinal axis of the reservoir, wherein the spray comprises droplets having an average diameter in the range of 20 to 200 μm.

Atomiser

Conveniently, said garment refreshing composition is provided as a liquid and said spray mechanism may comprise an atomiser configured to break up said liquid dose into droplets and thereby facilitate creation of said fine aerosol in the form of a mist.

Conveniently, said atomiser may comprise at least one of: a swirl chamber and a lateral dispersion chamber.

Suitably, the atomiser functions to mix air with the garment refreshing composition.

Reservoir/Container

Suitably the internal volume of the container, i.e. the size/capacity of the reservoir, is selected from: at least 100 ml, at least 200 ml, at least 300 ml, and at least 400 ml. Suitably the volume/size of reservoir is selected from: no more than 1000 ml, no more than 800 ml, no more than 600 ml, no more than 500 ml, no more than 400 ml, and no more than 300 ml. Suitable ranges are selected from: 100 to 300 ml, and 100 to 200 ml. Other suitable ranges are selected from 200 to 600 ml, 200 to 500 ml, and 300 to 500 ml.

These values apply also to removable/refillable reservoirs, which are discussed below.

Spray Device

Suitably the spray device is a manually operable spray device in the sense that the spray mechanism is manually operable to discharge a dose of said composition from the nozzle.

Said spray mechanism may comprise a hand-operable pump.

Optionally, said pump is one of: a positive displacement pump; a self-priming pump; a reciprocating pump.

Suitably the spray mechanism is operated by an actuator. The actuator can be a push actuator or a pull actuator.

Conveniently, said hand-held spray device is operable without the use of a pressurized propellant. Indeed, propellant-free spray devices are preferred.

Garment Refreshing Composition

The garment refreshing composition can be in any physical form, for example a solid such as a powder or granulate; or as a liquid such as an aqueous liquid.

Solid forms could be mixed with water prior to spraying.

A liquid is preferred.

The garment refreshing composition comprises at least one of an anti-malodour agent, an anti-wrinkle agent, and a perfume. Suitably at least two of these are present, i.e. an anti-malodour agent and an anti-wrinkle agent; or an anti-malodour agent and a perfume; or an anti-wrinkle agent and a perfume. Suitably all three, anti-wrinkle agent; anti-malodour agent and perfume, are present.

The garment refreshing composition suitably includes a carrier, which conveniently can be water, as discussed below.

As discussed below, the garment refreshing composition suitably contains encapsulates, for example perfume encapsulates, e.g. perfume microcapsules.

Thickening/Structuring Agent

Suitably the garment refreshing composition comprises a thickening agent and/or a structuring agent. These components may be present in an amount selected from: 0.1 to 60%, 0.1 to 50%, 0.1 to 40%, 0.1 to 30%, 0.1 to 20%, 0.1 to 10%, 0.1 to 5%, and 0.1 to 2% by weight based on the weight of the garment refreshing composition. This may permit control of the viscosity and/or rheology properties of the garment refreshing composition.

Aqueous Composition

The garment refreshing composition is suitably an aqueous garment refreshing composition.

Aqueous solutions are preferred for odour control. The dilute aqueous solution provides the maximum separation of anti-malodour agents (e.g. cyclodextrin molecules) on the fabric and thereby maximizes the chance that an odour molecule will interact with an anti-malodour agent.

The preferred carrier of the present invention is water. The water which is used can be distilled, deionized, or tap water. Water not only serves as the liquid carrier for the anti-malodour agent(s) such as cyclodextrins, but it also facilitates the complexation reaction between the anti-malodour agent (e.g. cyclodextrin molecules) and any malodourous molecules that are on the garment.

Suitably water is present in the garment refreshing composition in an amount selected from at least 50%, at least 75%, at least 85%, at least 90%, at least 95%, and at least 97%, by weight of the garment refreshing composition.

Encapsulates

In embodiments, one or more of the components in the garment refreshing composition is or are provided as an encapsulate. Microcapsules are preferred.

Encapsulated perfume is particularly preferred, especially perfume microcapsules (PMC).

Anti-Malodour Agent

The effective deposition of anti-malodour agents enables odours to be neutralised rather than merely masked. The fine mist achieved by the spray device of the present invention assists in achieving efficient deposition of the “active” anti-malodour agents and hence efficient neutralisation of malodours.

Anti-malodour agent may be present at a level selected from: less than 20%, less than 10%, and less than 5%, by weight of the garment refreshing composition. Suitably anti-malodour agent is present in the garment refreshing composition in an amount selected from the range of from about 0.01% to about 5%, preferably from about 0.1% to about 3%, more preferably from about 0.5% to about 2%, by weight of the garment refreshing composition.

Any suitable anti-malodour agent may be used. Indeed, an anti-malodour effect may be achieved by any compound or product that is effective to “trap”, “absorb” or “destroy” odour molecules to thereby separate or remove odour from the garment.

The odour control agent may be selected from the group consisting of: uncomplexed cyclodextrin; odour blockers; reactive aldehydes; flavanoids; zeolites; activated carbon; and mixtures thereof.

As noted above, a suitable anti-malodour agent is cyclodextrin, suitably water soluble uncomplexed cyclodextrin. Suitably cyclodextrin is present at a level selected from 0.01% to 5%, 0.1% to 4%, and 0.5% to 2% by weight of the garment refreshing composition.

As used herein, the term “cyclodextrin” includes any of the known cyclodextrins such as unsubstituted cyclodextrins containing from six to twelve glucose units, especially, alpha-cyclodextrin, beta-cyclodextrin, gamma-cyclodextrin and/or their derivatives and/or mixtures thereof. The alpha-cyclodextrin consists of six glucose units, the beta-cyclodextrin consists of seven glucose units, and the gamma-cyclodextrin consists of eight glucose units arranged in donut-shaped rings.

Preferably, the cyclodextrins are highly water-soluble such as, alpha-cyclodextrin and/or derivatives thereof, gamma-cyclodextrin and/or derivatives thereof, derivatised beta-cyclodextrins, and/or mixtures thereof. The derivatives of cyclodextrin consist mainly of molecules wherein some of the OH groups are converted to OR groups. Cyclodextrin derivatives include, e.g., those with short chain alkyl groups such as methylated cyclodextrins, and ethylated cyclodextrins, wherein R is a methyl or an ethyl group; those with hydroxyalkyl substituted groups, such as hydroxypropyl cyclodextrins and/or hydroxyethyl cyclodextrins, wherein R is a —CH₂—CH(OH)—CH₃ or a —CH₂CH₂—OH group; branched cyclodextrins such as maltose-bonded cyclodextrins; cationic cyclodextrins such as those containing 2-hydroxy-3-(dimethylamino)propyl ether, wherein R is CH₂—CH(OH)—CH₂—N(CH₃)₂ which is cationic at low pH; quaternary ammonium, e.g., 2-hydroxy-3-(trimethylammonio)propyl ether chloride groups, wherein R is CH₂—CH(OH)—CH₂—N⁺(CH₃)₃Cl⁻; anionic cyclodextrins such as carboxymethyl cyclodextrins, cyclodextrin sulfates, and cyclodextrin succinylates; amphoteric cyclodextrins such as carboxymethyl/quaternary ammonium cyclodextrins; cyclodextrins wherein at least one glucopyranose unit has a 3-6-anhydro-cyclomalto structure, e.g., the mono-3-6-anhydrocyclodextrins

Highly water-soluble cyclodextrins are those having water solubility of at least about 10 g in 100 ml of water at room temperature, preferably at least about 20 g in 100 ml of water, more preferably at least about 25 g in 100 ml of water at room temperature. The availability of solubilized, uncomplexed cyclodextrins is essential for effective and efficient odour control performance. Solubilized, water-soluble cyclodextrin can exhibit more efficient odour control performance than non-water-soluble cyclodextrin when deposited onto surfaces, especially fabric.

Examples of preferred water-soluble cyclodextrin derivatives suitable for use herein are hydroxypropyl alpha-cyclodextrin, methylated alpha-cyclodextrin, methylated beta-cyclodextrin, hydroxyethyl beta-cyclodextrin, and hydroxypropyl beta-cyclodextrin. Hydroxyalkyl cyclodextrin derivatives preferably have a degree of substitution of from about 1 to about 14, more preferably from about 1.5 to about 7, wherein the total number of OR groups per cyclodextrin is defined as the degree of substitution. Methylated cyclodextrin derivatives typically have a degree of substitution of from about 1 to about 18, preferably from about 3 to about 16. A known methylated beta-cyclodextrin is heptakis-2,6-di-O-methyl-β-cyclodextrin, commonly known as DIMEB, in which each glucose unit has about 2 methyl groups with a degree of substitution of about 14. A preferred, more commercially available, methylated beta-cyclodextrin is a randomly methylated beta-cyclodextrin, commonly known as RAMEB, having different degrees of substitution, normally of about 12.6. RAMEB is more preferred than DIMEB, since DIMEB affects the surface activity of the preferred surfactants more than RAMEB. The preferred cyclodextrins are available, e.g., from Cerestar U.S.A., Inc. and Wacker Chemicals (U.S.A.), Inc.

In embodiments mixtures of cyclodextrins are used.

“Odour blockers” can be used as an anti-malodour agent to mitigate the effects of malodours. Non-limiting examples of odour blockers include 4-cyclohexyl-4-methyl-2-pentanone, 4-ethylcyclohexyl methyl ketone, 4-isopropylcyclohexyl methyl ketone, cyclohexyl methyl ketone, 3-methylcyclohexyl methyl ketone, 4-tert.-butylcyclohexyl methyl ketone, 2-methyl-4-tert.butylcyclohexyl methyl ketone, 2-methyl-5-isopropylcyclohexyl methyl ketone, 4-methylcyclohexyl isopropyl ketone, 4-methylcyclohexyl secbutyl ketone, 4-methylcyclohexyl isobutyl ketone, 2,4-dimethylcyclohexyl methyl ketone, 2,3-dimethylcyclohexyl methyl ketone, 2,2-dimethylcyclohexyl methyl ketone, 3,3-dimethylcyclohexyl methyl ketone, 4,4-dimethylcyclohexyl methyl ketone, 3,3,5-trimethylcyclohexyl methyl ketone, 2,2,6-trimethylcyclohexyl methyl ketone, 1-cyclohexyl-1-ethyl formate, 1-cyclohexyl-1-ethyl acetate, 1-cyclohexyl-1-ethyl propionate, 1-cyclohexyl-1-ethyl isobutyrate, 1-cyclohexyl-1-ethyl n-butyrate, 1-cyclohexyl-1-propyl acetate, 1-cyclohexyl-1-propyl n-butyrate, 1-cyclohexyl-2-methyl-1-propyl acetate, 2-cyclohexyl-2-propyl acetate, 2-cyclohexyl-2-propyl propionate, 2-cyclohexyl-2-propyl isobutyrate, 2-cyclohexyl-2-propyl nbutyrate, 5,5-dimethyl-1,3-cyclohexanedione (dimedone), 2,2-dimethyl-1,3-dioxane-4,6-dione (Meldrum's acid), spiro-[4.5]-6,10-dioxa-7,9-dioxodecane, spiro-[5.5]-1,5-dioxa-2,4-dioxoundecane, 2,2-hydroxymethyl-1,3-dioxane-4,6-dione and 1,3-cyclohexadione. Odour blockers are disclosed in more detail in U.S. Pat. Nos. 4,009,253; 4,187,251; 4,719,105; 5,441,727; and 5,861,371, incorporated herein by reference.

Reactive aldehydes can be used as anti-malodour agent to mitigate the effects of malodours. Examples of suitable reactive aldehydes include Class I aldehydes and Class II aldehydes. Examples of Class I aldehydes include anisic aldehyde, o-allyl-vanillin, benzaldehyde, cuminic aldehyde, ethylaubepin, ethyl-vanillin, heliotropin, tolyl aldehyde, and vanillin. Examples of Class II aldehydes include 3-(4′-tert.butylphenyl)propanal, 2-methyl-3-(4′-tertbutylphenyl)propanal, 2-methyl-3-(4′-isopropylphenyl)propanal, 2,2-dimethyl-3-(4-ethylphenyl)propanal, cinnamic aldehyde, a-amyl-cinnamic aldehyde, and a-hexyl-cinnamic aldehyde. These reactive aldehydes are described in more detail in U.S. Pat. No. 5,676,163. Reactive aldehydes, when used, can include a combination of at least two aldehydes, with one aldehyde being selected from acyclic aliphatic aldehydes, non-terpenic aliphatic aldehydes, non-terpenic alicyclic aldehydes, terpenic aldehydes, aliphatic aldehydes substituted by an aromatic group and bifunctional aldehydes; and the second aldehyde being selected from aldehydes possessing an unsaturation alpha to the aldehyde function conjugated with an aromatic ring, and aldehydes in which the aldehyde group is on an aromatic ring. This combination of at least two aldehydes is described in more detail in WO 00/49120. As used herein, the term “reactive aldehydes” further encompasses deodourizing materials that are the reaction products of (i) an aldehyde with an alcohol, (ii) a ketone with an alcohol, or (iii) an aldehyde with the same or different aldehydes. Such deodourizing materials can be: (a) an acetal or hemiacetal produced by means of reacting an aldehyde with a carbinol; (b) a ketal or hemiketal produced by means of reacting a ketone with a carbinol; (c) a cyclic triacetal or a mixed cyclic triacetal of at least two aldehydes, or a mixture of any of these acetals, hemiacetals, ketals, hemiketals, or cyclic triacetals. These deodorizing perfume materials are described in more detail in WO 01/07095 incorporated herein by reference.

Flavanoids can also be used as anti-malodour agent. Flavanoids are compounds based on the C6-C3-C6 flavan skeleton. Flavanoids can be found in typical essential oils. Such oils include essential oil extracted by dry distillation from needle leaf trees and grasses such as cedar, Japanese cypress, eucalyptus, Japanese red pine, dandelion, low striped bamboo and cranesbill and can contain terpenic material such as alpha-pinene, beta-pinene, myrcene, phencone and camphene. Also included are extracts from tea leaf. Descriptions of such materials can be found in JP 02284997 and JP 04030855 incorporated herein by reference.

Metallic salts can also be used as anti-malodour agents for malodour control benefits. Examples include metal salts of fatty acids. Ricinoleic acid is a preferred fatty acid. Zinc salt is a preferred metal salt. The zinc salt of ricinoleic acid is especially preferred. A commercially available product is TEGO Sorb A30 ex Evonik. Further details of suitable metallic salts is provided below.

Zeolites can be used as anti-malodour agent. A useful class of zeolites is characterized as “intermediate” silicate/aluminate zeolites. The intermediate zeolites are characterized by SiO₂/AlO₂ molar ratios of less than about 10. Preferably the molar ratio of SiO₂/AlO₂ ranges from about 2 to about 10. The intermediate zeolites can have an advantage over the “high” zeolites. The intermediate zeolites have a higher affinity for amine-type odours, they are more weight efficient for odour absorption because they have a larger surface area, and they are more moisture tolerant and retain more of their odour absorbing capacity in water than the high zeolites. A wide variety of intermediate zeolites suitable for use herein are commercially available as Valfor® CP301-68, Valfor® 300-63, Valfor® CP300-35, and Valfor® CP300-56, available from PQ Corporation, and the CBV100® series of zeolites from Conteka. Zeolite materials marketed under the trade name Abscents® and Smellrite®, available from The Union Carbide Corporation and UOP are also preferred. Such materials are preferred over the intermediate zeolites for control of sulfur-containing odours, e.g., thiols, mercaptans. Suitably the zeolite material has a particle size of less than about 10 microns and is present in the garment refreshing composition at a level of less than about 1% by weight of the garment refreshing composition.

Activated carbon is another suitable anti-malodour agent. Suitable carbon material is a known absorbent for organic molecules and/or for air purification purposes. Often, such carbon material is referred to as “activated” carbon or “activated” charcoal. Such carbon is available from commercial sources under such trade names as; Calgon-Type CPG®; Type PCB®; Type SGL®; Type CAL®; and Type OL®. Suitably the activated carbon preferably has a particle size of less than about 10 microns and is present in the garment refreshing composition at a level of less than about 1% by weight of the garment refreshing composition.

Exemplar anti-malodour agents are as follows.

ODOBAN™ is manufactured and distributed by Clean Central Corp. of Warner Robins, Ga. Its active ingredient is alkyl (C14 50%, C12 40% and C16 10%) dimethyl benzyl ammonium chloride which is an antibacterial quaternary ammonium compound. The alkyl dimethyl benzyl ammonium chloride is in a solution with water and isopropanol. Another product by Clean Control Corp. is BIOODOUR CONTROL™ which includes water, bacterial spores, alkylphenol ethoxylate and propylene glycol.

ZEOCRYSTAL FRESH AIR MIST™ is manufactured and distributed by Zeo Crystal Corp. (a/k/a American Zeolite Corporation) of Crestwood, Ill. The liquid comprises chlorites, oxygen, sodium, carbonates and citrus extract, and may comprise zeolite.

To the extent any material described herein as an odour control agent might also be classified as another component described herein, for purposes of the present invention, such material shall be classified as an odour control agent.

Solvent and/or Plasticiser

Suitably the garment refreshing composition contains solvent and/or plasticizer. Solvents and plasticizers act to aid the natural ability of water to plasticize fibers. Acceptable solvents and plasticizers include compounds having from one to ten carbons. The following non-limiting classes of compounds are suitable: mono-alcohols, dials, polyhydric alcohols, ethers, ketones, esters, organic acids, and alkyl glyceryl ethers, and hydrocarbons. Preferred solvents are soluble in water and/or miscible in the presence of optional surfactant. Examples include methanol, ethanol, isopropanol, hexanol, 1,2-hexanediol, hexylene glycol, (e.g. 2-methyl-2,4-pentanediol), isopropylene glycol (3-methyl-1,3-butanediol), 1,2-butylene glycol, 2,3-butylene glycol, 1,3-butylene glycol, 1,4-butylene glycol, 1,3-propylene glycol, 1,2-propylene glycol, isomers of cyclohexanedimethanol, isomers of propanediol, isomers of butanediol, the isomers of trimethylpentanediol, the isomers of ethylmethylpentanediol, alcohol ethoxylates of 2-ethyl-1,3-hexanediol, 2,2,4-trimethyl-1,3-pentanediol, alcohol ethoxylates of 2,2,4-trimethyl-1,3-pentanediol glycerol, ethylene glycol, diethylene glycol, dipropylene glycol, sorbitol, butoxy ethoxy ethanol, 3-methyl-3-methoxybutanol, 3-methoxybutanol, 1-ethoxy-2-propanol, diethylene glycol monoethyl ether, diethylene glycol monopropyl ether, diethylene glycol monobutyl ether, triethylene glycol monoethyl ether, erythritol, and mixtures of solvents and plasticizers. When solvent is used, it is typically present at a level selected from at least 0.5%, at least 1%, at least 2%, at least 3%, and at least 4% by weight of the garment refreshing composition. Suitably it is present at a level selected from less than 30%, less than 25%, less than 20%, and less than 15% by weight of the garment refreshing composition.

Surfactant

Suitably the garment refreshing composition includes surfactant.

Surfactants may aid water (and hence garment refreshing composition) penetration into fibers. The surfactant provides a low surface tension that permits the garment refreshing composition to spread readily and more uniformly on hydrophobic surfaces like polyester and nylon. The spreading of the garment refreshing composition also allows it to dry faster. Surfactant also aids water in penetrating fabrics treated with hydrophobic fabric finishes that tend to repel water. Residual surfactant also helps keep fibrils fiat against the fiber surface, thus smoothing the surface and aiding in wrinkle release. Residual surfactant can also act to stiffen fibers, thus helping to prevent rewrinkling.

In embodiments the garment refreshing composition contains surfactant in an effective amount to improve the performance of the garment refreshing composition, suitably selected from 0.001%, from 0.01%, from 0.03%, from 0.05%, and from 0.1% by weight of the garment refreshing composition.

Suitably the surfactant is present in an amount selected from less than 20%, less than 15%, less than 10%, less than 5%, less than 2%, less than 1%, less than 0.5%, and less than 0.3% by weight of the garment refreshing composition.

Suitable ranges for the amount of surfactant are as follows: 0.001 to 20%, 0.001% to 5%, 0.01 to 5%, 0.01 to 2% by weight of the garment refreshing composition.

Suitably the surfactant is anti-malodour agent (e.g. cyclodextrin)-compatible, such that is it should not substantially form a complex with the anti-malodour agent so as to diminish performance of the agent and/or the surfactant. Complex formation diminishes both the ability of the agent to absorb odours and the ability of the surfactant to lower the surface tension of the aqueous garment refreshing composition.

Suitable anti-malodour agent-compatible surfactants can be readily identified by the absence of effect of the anti-malodour agent on the surface tension provided by the surfactant. This is achieved by determining the surface tension (in dyne/cm2) of aqueous solutions of the surfactant in the presence and in the absence of about 1% of a specific anti-malodour agent in the solutions. The aqueous solutions contain surfactant at concentrations of approximately 0.5%, 0.1%, 0.01%, and 0.005%. The anti-malodour agent can affect the surface activity of a surfactant by elevating the surface tension of the surfactant solution. If the surface tension at a given concentration in water differs by more than about 10% from the surface tension of the same surfactant in the 1% solution of the anti-malodour agent, that is an indication of a strong interaction between the surfactant and the anti-malodour agent. The preferred surfactants should have a surface tension in an aqueous solution that is different (lower) by less than about 10%, preferably less than about 5%, and more preferably less than about 1% from that of the same concentration solution containing 1% anti-malodour agent.

Examples of anti-malodour agent (e.g. cyclodextrin)-compatible nonionic surfactants include block copolymers of ethylene oxide and propylene oxide. Suitable block polyoxyethylene-polyoxypropylene polymeric surfactants, that are compatible with many agents, especially cyclodextrins, include those based on ethylene glycol, propylene glycol, glycerol, trimethylolpropane and ethylenediamine as the initial reactive hydrogen compound. Polymeric compounds made from a sequential ethoxylation and propoxylation of initial compounds with a single reactive hydrogen atom, such as C12-18 aliphatic alcohols, are not generally compatible with e.g. cyclodextrin. Certain of the block polymer surfactant compounds designated Pluronic® and Tetronic® by the BASF-Wyandotte Corp., Wyandotte, Mich., are readily available.

Silicone surfactants may be used because these compounds typically impart lubricity and smoothness to fibers that allows them to slip or glide easily past one another and therefore enhances the process of wrinkle release or wrinkle control.

A useful class of surfactants is nonionic silicone surfactants. Of these, the class of polyalkylene oxide polysiloxanes are suitable. Typically the polyalkylene oxide polysiloxanes have a dimethyl polysiloxane hydrophobic moiety and one or more hydrophilic polyalkylene chains. The hydrophilic polyakylene chains can be incorporated as side chains (pendant moieties) or as block copolymer moieties with the polysiloxane hydrophobic moiety. Nonlimiting examples of these type of surfactants are the Silwet® surfactants which are available from Crompton. Other nonlimiting examples of polyalkylene oxide polysiloxane include the following compounds available from Dow Coming® 193, 190, FF-400 Fluid, Q2-5220, Q4-3667, Q2-5211, as well as compounds available from Toray Dow Corning Silicone Co., Ltd.

A useful class of surfactants is non-ionic surfactants. For example a suitable type of nonionic surfactant is alkyl ethoxylated surfactant, such as addition products of ethylene oxide with fatty alcohols, fatty acids, fatty amines, etc. The ethoxylated surfactant includes compounds having the general formula:

R⁸—Z—(CH₂CH₂O)ₛB

wherein R⁸ is an alkyl group or an alkyl aryl group, selected from the group consisting of primary, secondary and branched chain alkyl hydrocarbyl groups, primary, secondary and branched chain alkenyl hydrocarbyl groups, and/or primary, secondary and branched chain alkyl- and alkenylsubstituted phenolic hydrocarbyl groups having from about 6 to about 20 carbon atoms, preferably from about 8 to about 18, more preferably from about 10 to about 15 carbon atoms; s is an integer from about 2 to about 45, preferably from about 2 to about 20, more preferably from about 2 to about 15; B is hydrogen, a carboxylate group, or a sulfate group; and linking group Z is selected from the group consisting of: —O—, —N(R)ₓ, —C(O)O—, —C(O)N(R)—, —C(O)N(R)—, and mixtures thereof, in which R, when present, is R⁸, a lower alkyl with about 1 to about 4 carbons, a polyalkylene oxide, or hydrogen, and x is 1 or 2.

Suitably these surfactants have an HLB (hydrophilic-lipophilic balance) of from about 5 to about 20, preferably from about 6 to about 15. Examples of commercially available surfactants are Neodol 91-2.5 (C9-C10, s=2.7, HLB=8.5), Neodol 23-3 (C12-C13, s=2.9, HLB=7.9) and Neodol 25-3 (C12-C15, s=2.8, HLB=7.5).

A useful class of surfactants is ionic surfactants. Anionic surfactants are particularly useful as they are least likely to leave residues. Ionic surfactant may also be selected from cationic and zwitterionic surfactants.

Suitable surfactants can be found in Surfactants and Interfacial Phenomena, 2nd Ed., Milton J. Rosen, 1989, John Wiley & Sons, Inc., pp. 7-16, which is hereby incorporated by reference. Suitable anionic surfactants can also be found in Handbook of Surfactants, M. R. Porter, 1991, Blackie & Son Ltd, pp. 54-115 and references therein, the disclosure of which is incorporated herein by reference. Suitable surfactants include Stepanol® WAC, Biosoft® 40 (Stepan Co., Northfield, Ill.). Anionic surfactants can also be created by sulfating or sulfonating animal or vegetable based oils. An example of these type of surfactants include sulfated canola oil and sulfated castor oil (Freedom SCO-75) available from the Freedom Chemical Co., Charlotte N.C. (owned by BF Goodrich).

Suitable cationic and zwitterionic surfactants can be found in the above mentioned Handbook of Surfactants, pp. 179-202 as well as in the above mentioned Surfactants and Interfacial Phenomena, pp. 17-20 and pp. 28-31 and references therein, the disclosures of which are hereby incorporated herein by reference.

A useful class of surfactants is Fluorine-based surfactants. Fluorocarbon surfactants comprise the class of surfactants wherein the hydrophobic part of the amphiphile comprises at least in part some portion of a carbon-based linear or cyclic moiety having fluorines attached to the carbon where typically hydrogens would be attached to the carbons together with a hydrophilic head group. Some typical nonlimiting fluorocarbon surfactants include fluorinated alkyl polyoxyalkylene, and fluorinated alkyl esters as well as ionic surfactants. Suitable examples include Zonyl® 9075, FSO, FSN, FS-300, FS-310, FSN-100, FSO-100, 65 FTS, TBC from DuPont and Fluorad™ surfictants FC-430, FC-431, FC-740, FC-99, FC-120, FC-754, FC170C, and FC-171 from the 3M™ company in St. Paul, Minn.

Antimicrobial

In some embodiments the garment refreshing composition contains an effective amount, to kill, or reduce the growth of microbes, of water soluble antimicrobial active, preferably from about 0.001% to about 0.8%, more preferably from about 0.002% to about 0.3%, even more preferably from about 0.003% to about 0.2%, by weight of the garment refreshing composition, and preferably selected from the group consisting of halogenated compounds, cyclic nitrogen compounds, quaternary compounds, and phenolic compounds.

A wide range of quaternary compounds can also be used as antimicrobial actives. Non-limiting examples of useful quaternary compounds include: (1) benzalkonium chlorides and/or substituted benzalkonium chlorides such as commercially available Barquat® (available from Lonza), Maquat® (available from Mason), Variquat® (available from Witco/Sherex), and Hyamine® (available from Lonza); (2) di(C6-C14)alkyl di short chain (C1-4 alkyl and/or hydroxyalkyl) quarternary such as Bardac® products of Lonza, (3) N-(3-chloroallyl)hexaminium chlorides such as Dowicide® and Dowicil® available from Dow; (4) benzethonium chloride such as Hyamine® 1622 from Rohm & Haas; (5) methylbenzethonium chloride represented by Hyamine® 10× supplied by Rohm & Haas, (6) cetylpyridinium chloride such as Cepacol chloride available from of Merrell Labs. Examples of the preferred dialkyl quaternary compounds are di(C8-C12)dialkyl dimethyl ammonium chloride, such as didecyldimethylammonium chloride (Bardac 22), and dioctyldimethylammonium chloride (Bardac 2050). Typical concentrations for biocidal effectiveness of these quaternary compounds range from about 0.001% to about 0.8%, preferably from about 0.005% to about 0.3%, more preferably from about 0.01% to about 0.2%, and even more preferably from about 0.03% to about 0.1%, by weight of the garment refreshing composition.

When antimicrobials and surfactants are used together, they may provide improved antimicrobial action. This is especially true for the siloxane surfactants, and especially when the siloxane surfactants are combined with the chlorhexidine antimicrobial actives.

Low Molecular Weight Polyol

In embodiments, the garment refreshing composition contains from about 0.01% to about 3%, more preferably from about 0.05% to about 1%, and even more preferably from about 0.1% to about 0.5%, by weight of the garment refreshing composition of low molecular weight polyol.

Low molecular weight polyols with relatively high boiling points, as compared to water, such as ethylene glycol, diethylene glycol, triethylene glycol, propylene glycol, dipropylene glycol, and/or glycerine are preferred optional ingredients for improving odour control performance of the garment refreshing composition.

It is believed that the polyols' ability to remain for a longer period of time than water allows it to form ternary complexes with the anti-malodour agent (e.g. cyclodextrin) and some malodourous molecules. In the case of cyclodextrins the addition of the glycols is believed to fill up void space in the cyclodextrin cavity that is unable to be totally filled by some malodour molecules of relatively smaller sizes. Preferably the glycol used is glycerine, ethylene glycol, propylene glycol, dipropylene glycol or mixtures thereof, more preferably ethylene glycol and propylene glycol. Cyclodextrins prepared by processes that result in a level of such polyols are highly desirable, since they can be used without removal of the polyols.

Some polyols, e.g., dipropylene glycol, are also useful to facilitate the solubilization of some perfume ingredients in the garment refreshing composition of the present invention.

Chelator

In embodiments, the garment refreshing composition contains from about 0.001% to about 0.3%, preferably from about 0.01% to about 0.1%, more preferably from about 0.02% to about 0.05%, by weight of the garment refreshing composition of aminocarboxylate chelator.

Chelators, e.g., ethylenediaminetetraacetic acid (EDTA), hydroxyethylenediaminetriacetic acid, diethylenetriaminepentaacetic acid, and other aminocarboxylate chelators, and mixtures thereof, and their salts, and mixtures thereof, can optionally be used to increase antimicrobial and preservative effectiveness against Gram-negative bacteria, especially Pseudomonas species. Although sensitivity to EDTA and other aminocarboxylate chelators is mainly a characteristic of Pseudomonas species, other bacterial species highly susceptible to chelators include Achromobacter, Alcaligenes, Azotobacter, Escherichia, Salmonella, Spirillum, and Vibrio. Other groups of organisms also show increased sensitivities to these chelators, including fungi and yeasts. Furthermore, aminocarboxylate chelators can help, e.g., maintaining product clarity, protecting fragrance and perfume components, and preventing rancidity and off odours.

Metallic Salt

In embodiments, the garment refreshing composition contains an effective amount of metallic salt, preferably from about 0.1% to about 10%, more preferably from about 0.2% to about 8%, even more preferably from about 0.3% to about 5% by weight of the garment refreshing composition, especially water soluble copper and/or zinc salts, for improved odour benefit;

Optionally, the garment refreshing composition can include metallic salts for added odour absorption and/or antimicrobial benefit. The metallic salts are selected from the group consisting of copper salts, zinc salts, and mixtures thereof.

Copper salts have some antimicrobial benefits. Specifically, cupric abietate acts as a fungicide, copper acetate acts as a mildew inhibitor, cupric chloride acts as a fungicide, copper lactate acts as a fungicide, and copper sulfate acts as a germicide. Copper salts also possess some malodour control abilities. See U.S. Pat. No. 3,172,817, Leupold, et al., which discloses deodourizing compositions for treating disposable articles, comprising at least slightly water-soluble salts of acylacetone, including copper salts and zinc salts, all of said patents are incorporated herein by reference.

The preferred zinc salts possess malodour control abilities. Zinc has been used most often for its ability to ameliorate malodour, e.g., in mouth wash products, as disclosed in U.S. Pat. No. 4,325,939, issued Apr. 20, 1982 and U.S. Pat. No. 4,469,674, issued Sep. 4, 1983, to N. B. Shah, et al., all of which are incorporated herein by reference. Highly-ionized and soluble zinc salts such as zinc chloride, provide the best source of zinc ions. Zinc borate functions as a fungistat and a mildew inhibitor, zinc caprylate functions as a fungicide, zinc chloride provides antiseptic and deodourant benefits, zinc ricinoleate functions as a fungicide, zinc sulfate heptahydrate functions as a fungicide and zinc undecylenate functions as a fungistat. As noted above, zinc ricinoleate is available as TEGO Sorb A30 ex Evonik.

Preferably the metallic salts are water-soluble zinc salts, copper salts or mixtures thereof, and more preferably zinc salts, especially ZnCl₂. These salts are preferably present in the present invention primarily to absorb amine and sulfur-containing compounds. In particular, for cyclodextrin-containing compositions, they serve to absorb such compounds that have molecular sizes too small to be effectively complexed with the cyclodextrin molecules. Low molecular weight sulfur-containing materials, e.g., sulfide and mercaptans, are components of many types of malodours, e.g., food odours (garlic, onion), body/perspiration odour, breath odour, etc. Low molecular weight amines are also components of many malodours, e.g., food odours, body odours, urine, etc.

Carbonate/Bicarbonate Salts

Water-soluble alkali metal carbonate and/or bicarbonate salts, such as sodium bicarbonate, potassium bicarbonate, potassium carbonate, caesium carbonate, sodium carbonate, and mixtures thereof can be added to the garment refreshing composition in order to help to control certain acid-type odours. Preferred salts are sodium carbonate monohydrate, potassium carbonate, sodium bicarbonate, potassium bicarbonate, and mixtures thereof. When these salts are added to the garment refreshing composition they are typically present at a level of from about 0.1% to about 5%, preferably from about 0.2% to about 3%, more preferably from about 0.3% to about 2%, by weight of the garment refreshing composition.

Enzyme

In embodiments, the garment refreshing composition contains an effective amount of enzyme, from about 0.0001% to about 0.5%, preferably from about 0.001% to about 0.3%, more preferably from about 0.005% to about 0.2% by weight of the garment refreshing composition, for improved odour control benefit. Proteases are particularly useful. Suitable water soluble proteases are pepsin, tripsin, ficin, bromelin, papain and rennin. Commercially available enzymes include ESPERASE®, ALCALASE® and SAVINASE® by Novo Industries NS (Denmark) and MAXATASE® by International Bio-Synthetics, Inc. (The Netherlands).

Antimicrobial Preservative

In embodiments, the garment refreshing composition contains an effective amount of solubilized, water-soluble, antimicrobial preservative, preferably from about 0.0001% to about 0.5%, more preferably from about 0.0002% to about 0.2%, most preferably from about 0.0003% to about 0.1%, by weight of the garment refreshing composition.

Fabric Care Polysaccharides

The garment refreshing composition suitably includes a fabric care polysaccharide.

Suitable fabric care polysaccharides are those which have a globular conformation in dilute aqueous solution, via a random coiling structure. Said polysaccharides include homo- and/or hetero-polysaccharides with simple helical structure with or without branching, e.g., with 1,4-a-linked backbone structure (e.g. 1,4-α-glucan, 1,4-α-xylan) with or without branching, 1,3-β-linked backbone with or without branching (e.g., galactan), and all 1,6-linked backbones with or without branching (e.g., dextran, pullulan, pustulan), and with a weight-average molecular weight of from about 5,000 to about 500,000, preferably from about 8,000 to about 250,000, more preferably from about 10,000 to about 150,000, typically with sizes ranging from about 2 nm to about 300 nm, preferably from about 3 nm to about 100 nm, more preferably from about 4 nm to about 30 nm. The size is defined as the gyration length occupied by the molecule in dilute aqueous solutions.

A suitable level of fabric care polysaccharide with globular structure is selected from 0.01% to 5%, 0.05% to 2%, 0.1% to 1%, by weight of the garment refreshing composition.

Preferably the fabric care polysaccharide is selected from the group consisting of arabinogalactan, pachyman, curdlan, callose, paramylon, sceleroglucan, lentinan, lichenan, laminarin, szhizophyllan, grifolan, sclerotinia sclerotiorum glucan (SSG), Ompharia lapidescence glucan (OL-2), pustulan, dextran, pullulan, substituted versions thereof and derivatised versions thereof.

A suitable fabric care branched polysaccharide with 1,3-β-linked backbone is arabinogalactan (also named as galactoarabinan or epsilon-galactan). Examples of other fabric care polysaccharides that have 1,3-β-linkage as a part of the backbone include: 1,3-β-xylan (from, e.g. Pencillus dumetosus), curdlen, a 1,3-β-glucan (from e.g., Alcaligenes faecalis), paramylon B, a 1,3-β-glucan (from, e.g., Euglena gracilis), lichenin, a (1,3),(1,4)-β-glucan (from various sources including Cetraria islandica), sceleroglucan, a (1,3),(1,6)-β-glucan (from, e.g. Sclerotium rolfii), and lentinen, a (1,3),(1,6)-β-glucan (from, e.g., Lentinus edodes). More details about these and other polysaccharides with 1,3-β-linked backbone are given in “Chemistry and Biology of (1→3)-β-Glucans”, B. A Stone and A E. Clarke, La Trobe University Press, Victoria, Australia, 1992, pp. 68-71, and 82-83, incorporated herein by reference.

Anti-Wrinkle Agent

Anti-wrinkle encompasses the function of removing or reducing wrinkling and such “de-wrinkling” or “wrinkle release” has been demonstrated in consumer panel studies using spray devices of the present invention.

Suitably the anti-wrinkle agent is present in the garment refreshing composition in an amount selected from at least 0.01%, at least 0.1%, and at least 0.5% by weight of the garment refreshing composition. Suitably the anti-wrinkle agent is present in the garment refreshing composition in an amount selected from: no more than 10%, no more than 8%, no more than 6%, no more than 5%, no more than 4%, no more than 3%, and no more than 2.5% by weight of the garment refreshing composition. Suitable rages can be selected from: 0.01 to 10%, 0.01 to 5%, 0.1 to 5%, 0.1 to 3%, and 0.1 to 2.5% by weight of the garment refreshing composition.

Suitably the garment refreshing composition contains a silicone anti-wrinkle agent.

Perfume

Suitably the garment refreshing composition contains perfume. Suitably the perfume is present in an amount selected from: 0.001 to 5%, 0.001 to 2%, 0.01 to 1%, 0.001 to 1%, and 0.003% to 1% by weight of the garment refreshing composition

For example, the garment refreshing composition can provide a “scent signal” in the form of a pleasant odour which provides a freshness impression to the treated fabrics. The scent signal can be designed to provide a fleeting perfume scent. When perfume is added as a scent signal, it is added only at very low levels, e.g., from about 0% to about 0.5%, preferably from about 0.003% to about 0.3%, more preferably from about 0.005% to about 0.2%, by weight of the garment refreshing composition. Perfume can also be added as a more intense odour in product and on fabrics. When stronger levels of perfume are preferred, relatively higher levels of perfume can be added. Examples of perfume ingredients that are especially suitable for application to garments are given in U.S. Pat. No. 5,445,747, issued Aug. 29, 1995 to Kvietok et al., incorporated herein by reference.

When long lasting fragrance odour on garments is desired, it is preferred to use at least an effective amount of perfume ingredients which have a boiling point of about 300° C. or higher. Examples of such preferred ingredients are given in U.S. Pat. No. 5,500,138, issued Mar. 19, 1996 to Bacon et al., incorporated herein by reference. It is also preferred to use materials that can slowly release perfume ingredients after the garment is treated by garment refreshing composition. Examples of materials of this type are given in U.S. Pat. No. 5,531,910, Severns et al., issued Jul. 2, 1996, said patent being incorporated herein by reference.

Preferably the perfume is hydrophilic and is composed predominantly of ingredients selected from two groups of ingredients, namely, (a) hydrophilic ingredients having a ClogP of less than about 3.5, more preferably less than about 3.0, and (b) ingredients having significant low detection threshold, and mixtures thereof. Typically, at least about 50%, preferably at least about 60%, more preferably at least about 70%, and most preferably at least about 80% by weight of the perfume is composed of perfume ingredients weight of the perfume is composed of perfume ingredients of the above groups (a) and (b).

Regarding (a) hydrophilic perfume ingredients, the hydrophilic perfume ingredients are more soluble in water, have less of a tendency to complex with the cyclodextrins, and are more available in the garment refreshing composition than the ingredients of conventional perfumes. The degree of hydrophobicity of a perfume ingredient can be correlated with its octanol/water partition coefficient P. The octanol/water partition coefficient of a perfume ingredient is the ratio between its equilibrium concentration in octanol and in water. A perfume ingredient with a greater partition coefficient P is considered to be more hydrophobic. Conversely, a perfume ingredient with a smaller partition coefficient P is considered to be more hydrophilic. Since the partition coefficients of the perfume ingredients normally have high values, they are more conveniently given in the form of their logarithm to the base 10, log P. Thus the preferred perfume hydrophilic perfume ingredients of this invention have log P of about 3.5 or smaller, preferably of about 3.0 or smaller.

The log P of many perfume ingredients have been reported; for example, the Pomona92 database, available from Daylight Chemical Information Systems, Inc. (Daylight CIS), Irvine, Calif., contains many, along with citations to the original literature. However, the log P values are most conveniently calculated by the “CLOGP” program, also available from Daylight CIS. This program also lists experimental log P values when they are available in the Pomona92 database. The “calculated log p” (ClogP) is determined by the fragment approach of Hansch and Leo (cf., A Leo, in Comprehensive Medicinal Chemistry, Vol. 4, C. Hansch, P. G. Sammens, J. B. Taylor and C. A. Ramsden, Eds., p. 295, Pergamon Press, 1990, incorporated herein by reference). The fragment approach is based on the chemical structure of each perfume ingredient, and takes into account the numbers and types of atoms, the atom connectivity, and chemical bonding. The ClogP values, which are the most reliable and widely used estimates for this physicochemical property, are used instead of the experimental log P values in the selection of perfume ingredients herein.

Regarding (b) low odour detection threshold perfume ingredients, the odour detection threshold of an odourous material is the lowest vapor concentration of that material which can be olfactorily detected. The odour detection threshold and some odour detection threshold values are discussed in, e.g., “Standardized Human Olfactory Thresholds”, M. Devos et al, IRL Press at Oxford University Press, 1990, and “Compilation of Odour and Taste Threshold Values Data”, F. A Fazzalari, editor, ASTM Data Series DS 48A, American Society for Testing and Materials, 1978, both of said publications being incorporated by reference. The use of small amounts of perfume ingredients that have low odour detection threshold values can improve perfume odour character, even though they are not as hydrophilic as perfume ingredients of group (a) which are given hereinabove. Perfume ingredients that do not belong to group (a) above, but have a significantly low detection threshold, useful in the garment refreshing composition, are selected from the group consisting of ambrox, bacdanol, benzyl salicylate, butyl anthranilate, cetalox, damascenone, alpha-damascone, gammadodecalactone, ebanol, herbavert, cis-3-hexenyl salicylate, alpha-ionone, beta-ionone, alpha-isomethylionone, lilial, methyl nonyl ketone, gamma-undecalactone, undecylenic aldehyde, and mixtures thereof. These materials are preferably present at low levels in addition to the hydrophilic ingredients of group (a), typically less than about 20%, preferably less than about 15%, more preferably less than about 10%, by weight of the total perfume compositions. However, only low levels are required to provide an effect.

As noted above, suitably perfume is provided in an encapsulated form, for example as a perfume microcapsule (PMC).

Other Composition Features

The garment refreshing composition can optionally contain other adjunct odour-controlling materials, chelating agents, additional antistatic agents if more static control is desired, insect and moth repelling agents, colorants, especially bluing agents, viscosity control agents, and mixtures thereof in addition to the above listed components, e.g., polymers. The total level of optional ingredients is preferably less than about 10%, more preferably less than about 5% even more preferably less than about 3%, and still more preferably less than about 2%, by weight of the garment refreshing composition. These optional ingredients exclude the other ingredients specifically mentioned hereinbefore. Other optional materials are antistatic agents, insect or moth repelling agent, optional colorant, optional anti-clogging agent, and mixtures thereof of optional ingredients.

Suitably the garment refreshing composition is substantially free, suitably essential free of, suitably free of, any material that would soil or stain garment fabric under usage conditions.

Garments

The garment can be any article of clothing.

The applicant has observed that the malodours and odour-causing agents, and indeed the accumulation patterns of such malodours and odour-causing agents is characteristic of garments and is different from other materials such as hard surfaces and household upholstery. In the same way as the washing of garments benefits from a cleaning formulation and cleaning process that is tailored to garments, in contrast to a differently tailored formulation and process for e.g. upholstery, so the garment refreshing composition (and its associated spray device) may be tailored to garment refresh.

Replacement Reservoir and Kits

According to a second aspect of the present invention, there is provided a replacement reservoir for a garment refresh product according to the above aspect(s), the replacement reservoir being pre-filled with a volume of said garment refreshing composition for replenishment of said product.

The replacement reservoir may be rigid or flexible. The replacement reservoir may comprise one or more rigid walls and/or one or more flexible walls. In the case of a flexible reservoir, the reservoir may take the form of a pouch.

Suitably the replacement reservoir is elongate and has an engagement portion extending axially along a longitudinal axis of the elongate reservoir for engagement with a receiving or mating portion of the spray device. Conveniently the shroud includes said receiving or mating portion. Suitably the engagement portion of the releasable reservoir comprises a threaded portion for threaded engagement with the receiving portion of the spray device.

For example the replaceable reservoir may comprise an upstanding annular lip that is provided with an external screw thread for threaded engagement with a re-entrant region of the shroud that comprises an internally threaded recess.

Conveniently the replacement reservoir may be provided in a kit. Indeed, a further aspect related to the second aspect of the present invention is a kit comprising a replacement reservoir.

A suitable “refill kit” comprises one or more reservoirs. In the case of more than one reservoir, for example two, three, four, five, or more reservoirs, the contents (garment refreshing composition) of each reservoir may the same as or different from the other reservoirs. For example, the kit may include multiple reservoirs each having different anti-malodour agents and/or different anti-wrinkle agents and/or perfumes.

The kit may contain instructions, for example instructions relating to the attachment/detachment of the reservoir to the spray mechanism/shroud.

In the case where the kit contains reservoirs with different garment refresh compositions (e.g. comprising different perfumes) the instructions may also provide guidance as to the selection of a reservoir to match with the intended use, e.g. the type of garment that is to be refreshed.

In embodiments, the kit comprises a spray device of any one of the previous aspects, and at least one, suitably two or more, replacement reservoirs.

The Garment Refresh Spray

According to a third aspect of the present invention, there is provided a garment refresh spray comprising a fine mist formed from a garment refreshing composition comprising at least one of: an anti-malodour agent; an anti-wrinkle compound; and a perfume; wherein said spray has a cone angle in the range of 55 to 80 degrees; and said mist is formed from a dose of between 0.25 and 1.5 ml of said garment refreshing composition and which comprises droplets having an average diameter in the range of 20 to 200 μm.

Method of Creating the Garment Refresh Spray

According to a fourth aspect of the present invention, there is provided a method of creating a garment refresh spray according to the above aspect, the method involving the provision and operation of a product (spray device) according to any one of the previous aspects.

Method of Refreshing a Garment

According to a fifth aspect of the present invention, there is provided a method of refreshing a garment comprising the step of operating a product (spray device) according to any one of the previous aspects so as to direct the spray output of the device on to the garment.

According to a sixth aspect of the present invention, there is provided a method of refreshing a garment comprising the step of applying the garment refresh spray of the above aspect to the garment.

Use of Spray Device

According to a seventh aspect of the present invention, there is provided a use of a product (spray device) according to any one of the previous aspects to apply a garment refreshing composition to a garment so as to refresh the garment.

According to an eighth aspect of the present invention, there is provided a use of a garment refresh spray according to the above aspect to refresh the garment.

### Definitions

As used herein “aerosol” means a colloid of either dry particles or liquid droplets (of the garment refreshing composition) suspended in air. Liquid droplets are of particular interest. An aerosol may be produced using a propellant (in which case the spray device may be referred to by the informal term “aerosol-type device) or without a propellant. As noted elsewhere, the present invention is particularly concerned with non-propellant devices.

As used herein “garment” means clothes/clothing. It does not include materials or fabrics that are part of household furnishings, carpets, curtains and the like. And so mention herein of “fabric” means, unless indicated to the contrary, “garment fabric”.

Combinations

Each one of the proposals and associated aspects and optional features is combinable with any one or more of the other proposals and its/their associated aspects and optional features.

### DESCRIPTION OF EMBODIMENTS AND EXPERIMENTS

So that the invention may be more readily understood, and so that further features thereof may be appreciated, embodiments of the invention will now be described by way of example with reference to the accompanying drawings in which:

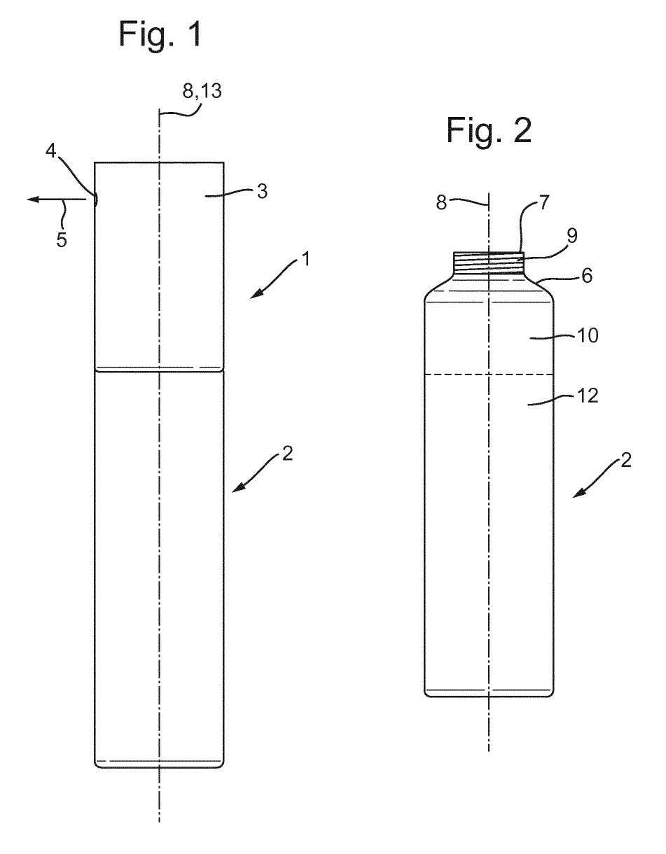

FIG. 1 is a side elevational view showing a fabric refresh product according to one possible embodiment of the present invention;

FIG. 2 is a side elevational view showing a liquid reservoir of the product illustrated in FIG. 1, with a shroud and associated spray mechanism of the product removed;

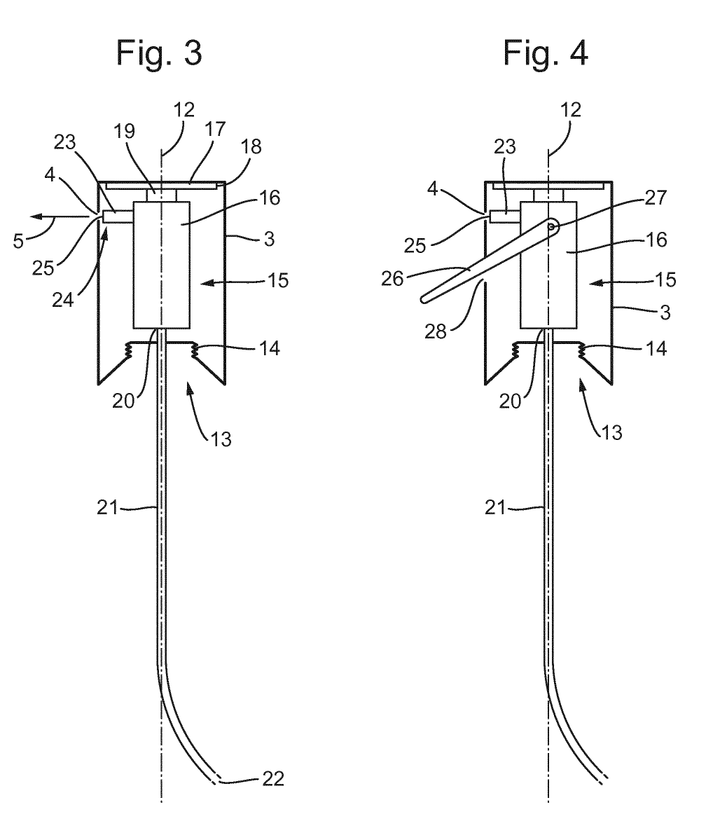

FIG. 3 is a schematic part-sectional view showing a shroud and associated spray mechanism of the product;

FIG. 4 is a schematic part-sectional view, generally similar to that of FIG. 3, but which shows an alternative configuration of shroud and spray mechanism; and

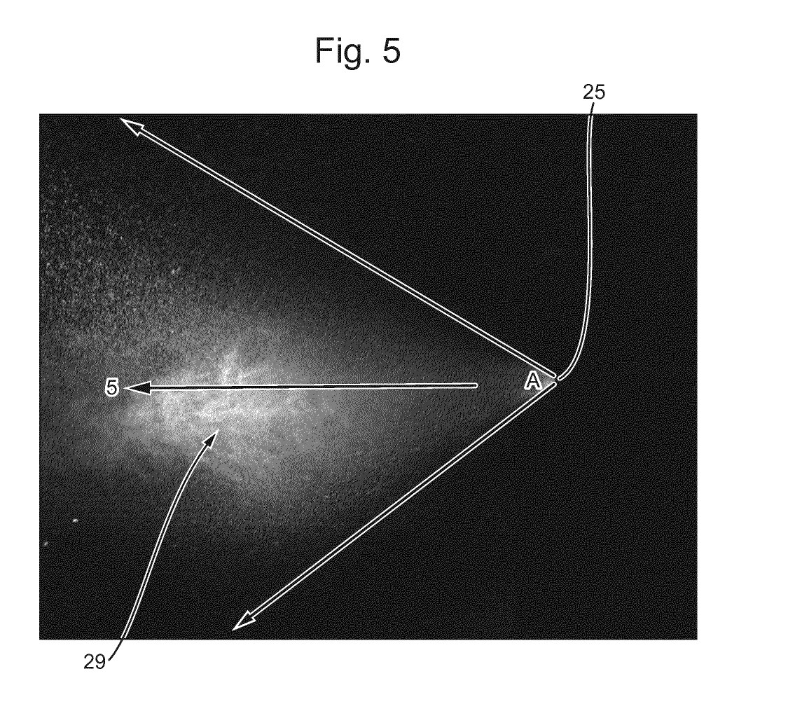

FIG. 5 is a side elevational view showing an exemplary fine mist spray, which may be produced by the product.

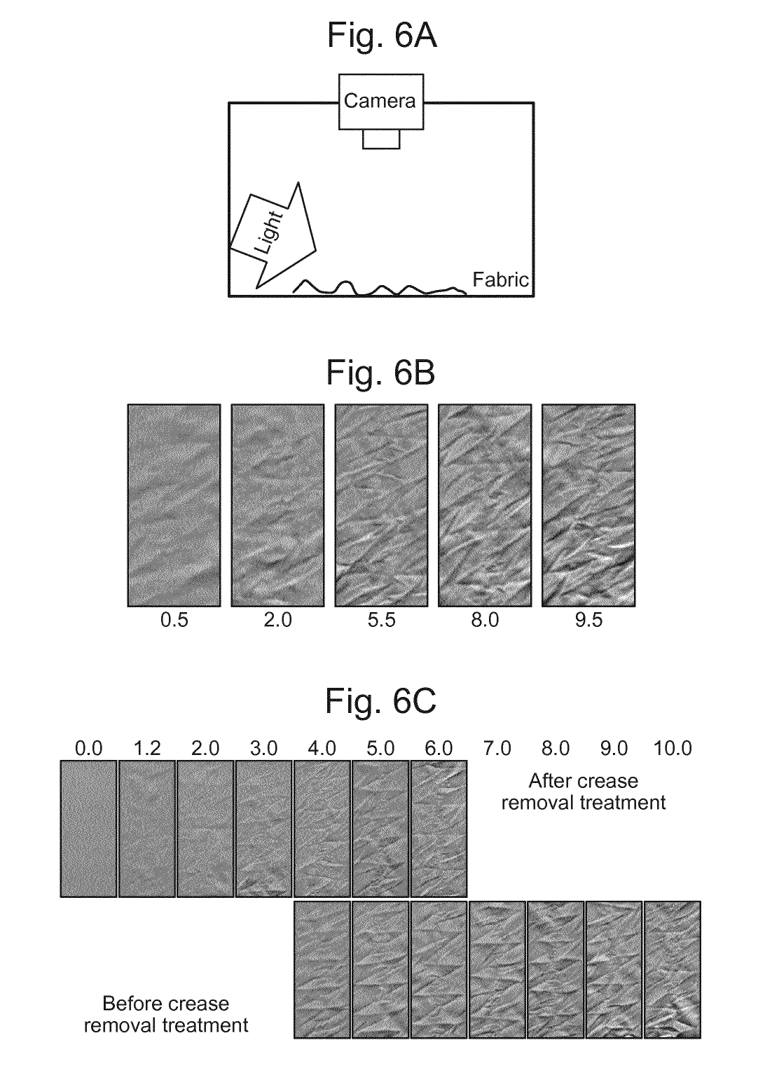

FIG. 6A is a schematic illustration of a garment sample imaging apparatus, comprising a camera, enclosure, garment sample and incident light.

FIG. 6B shows images of garment samples and their associated creasing scores derived from sensory panel evaluation.

FIG. 6C shows images of garment samples before and after application of anti-wrinkle (crease removal) garment refreshing composition, and associated creasing scores.

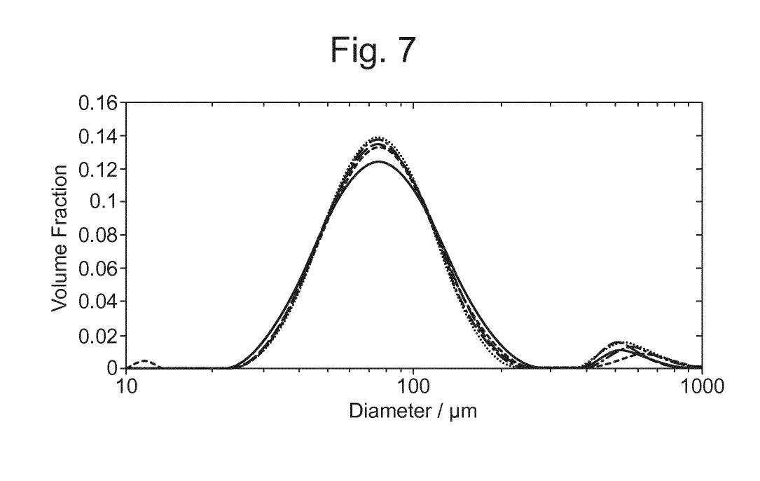

FIG. 7 shows droplet size distribution plots acquired from measurements on a Malvern Spraytec instrument, with the peak maximum corresponding to the average droplet size.

Turning now to consider the figures in more detail, FIG. 1 illustrates an exemplary embodiment of a fabric refresh product in accordance with the invention, which it is envisaged will be provided in the form of a hand-held spray device. In general terms, the product 1 comprises a container 2, on top of which there is provided a shroud 3. The container 2 may be provided in the form of a bottle, and defines a reservoir for the receipt of a volume of a garment refreshing composition, as will be described in more detail below. It is proposed that the shroud 3 will house a spray mechanism which is configured to draw a dose of the garment refreshing composition from the container 2, atomise the dose, and discharge the atomised dose through a side outlet aperture 4 provided in the shroud 3, the atomised dose being discharged in the form of a fine aerosol and in a spray direction indicated generally at 5.

Whilst in its broadest sense, the present invention should be understood as relating to the production of a fine aerosol in the form of a colloid of either dry particles or liquid droplets of the garment refreshing composition suspended in air, embodiments of the invention will be described which are specifically configured for the production of a fine aerosol in form of a mist of liquid droplets in air, such that the garment refreshing composition 12 will be provided in the form of a liquid rather than, for example, a dry powder.

Reservoir/Container

Turning now to consider FIG. 2, an exemplary reservoir-defining container 2 is illustrated in more detail, with the shroud 3 removed. As will be noted, the particular configuration of container 2 illustrated is shown provided in the form of an elongate and generally straight-sided cylindrical bottle, having an inwardly tapered upper shoulder region 6 which narrows to define an upstanding annular lip 7 at the uppermost end of the container and which is centred on the longitudinal axis 8 of the container. The lip 7 is shown to have an external screw thread 9 to facilitate releasable engagement between the container 2 and the shroud 3. As will become apparent, however, other forms of releasable engagement between the container 2 and the shroud 3 are possible.

As will be appreciated, the reservoir-defining container 2 defines an internal volume 10 for the receipt of a garment refreshing composition 12. It is proposed that the product 1 will be provided to an end user in an initial pre-filled condition, in which the reservoir will already be substantially filled with an appropriate volume of the garment refreshing composition 12.

It is envisaged that in some embodiments the container 2 will be moulded from a suitable plastic material of a type known for use in the consumer products field. However, it is also possible for the container 2 to be formed from, or at least to comprise, glass.

It is also to be appreciated that whilst the garment refreshing composition-containing reservoir of the embodiments disclosed herein is defined by the container 2 itself, other variants are envisaged in which the reservoir might be provided as a separate vessel containing the garment refreshing composition 12, the vessel simply being housed and supported within the container 2.

Garment Refreshing Composition

Illustrative aqueous garment refreshing compositions suitable for use in the spray devices of FIGS. 1 to 4 include one or more of the following.

0.01 to 5 wt % anti-malodour compound (e.g. cyclodextrin or zinc ricinoleate)

0.01 to 2% surfactant

0.001 to 0.8% antimicrobial

0.01 to 3% low molecular weight polyol

0.001 to 0.3% aminocarboxylate chelator

0.1 to 10% metallic salt

0.0001 to 0.5% enzyme

0.0001 to 0.5% antimicrobial preservative

0.1 to 2.5 wt % anti-wrinkle compound (e.g. a silicone anti-wrinkle compound)

0.001 to 5 wt % perfume (especially encapsulated perfume such as PMCs)

Balance Water

Shroud

Aspects of the shroud 3 are illustrated schematically in more detail in FIG. 3.

The particular configuration of the shroud 3 illustrated is somewhat elongate and is cylindrical in form, having a longitudinal axis 12. It is envisaged that in some embodiments the shroud 3 will be moulded from a suitable plastic material. More particularly, the particular shroud 3 illustrated is configured so as to have a diameter which is substantially equal to that of the container 2, such that when mounted to the container 2 as illustrated in FIG. 1, the shroud 3 and the container 1 combine to form a generally straight-sided and elongate product 1.

The lowermost end of the shroud 3 is provided with a re-entrant formation 13 which is configured to receive and engage the uppermost end of the container 2. In particular, the re-entrant region 13 comprises an internally threaded recess 14 which is sized and configured to threadedly engage the correspondingly threaded lip 7 of the container 2 in a conventional manner, thereby providing a convenient means to releasably interengage the shroud 3 and the container 2. As will be appreciated, having regard to FIG. 1 in particular, when the shroud 3 and the container 2 are interengaged in this manner, the shroud will be mounted to the container 2 so as to extend upwardly therefrom and will be aligned with the longitudinal axis 8 of the container 2. Indeed the longitudinal axis 13 of the shroud 3 will be coincident with the longitudinal axis 8 of the container 2.

It is to be noted, however, that whilst the shroud 3 and the container 2 described above are configured for releasable engagement via a threaded connection, other forms of connection may be used instead. For example, variants are envisaged in which the shroud 3 and the container 2 may be configured for releasable engagement as an interference fit. Such an arrangement could be achieved by sizing an un-threaded recess 14 of the shroud such that it receives and engages an un-threaded lip 7 of the container as a close sliding fit, such that the recess 14 and/or the lip 7 will resiliently deform as they are slidingly interengaged to provide a secure, but releasable, interconnection.

Because the container 2 and the shroud 3 are releasable from one another as described above, the container 2 may be removed from the shroud 3 and its associated spray mechanism when its initial supply of the garment refreshing composition 12 has become depleted, thereby facilitating replenishment of the product 1. This may be achieved either by replacing the initial container 2 with a replacement one filled with the garment refreshing composition 12, or simply by refilling the original container 2.

Spray Mechanism

With reference again to FIG. 3, it is to be noted that the shroud 3 houses a spray mechanism, indicated generally at 15. As will become apparent, the spray mechanism 15 is configured for manual operation, by hand, by a user of the product 1, and comprises a spray mechanism such that it is operable without the use of a pressurized propellant of the sort used in so-called “aerosol sprays”.

The spray mechanism 15 may thus comprise a hand-operable pump 16, which may take any convenient form such as, for example, a positive displacement pump, a self-priming pump, or a reciprocating pump. The pump 16 is mechanically connected to an actuator, which in the particular arrangement illustrated in FIG. 3 takes the form of a push-button 17 which is accommodated within an aperture 18 provided through the upper end of the shroud 3, for convenient actuation by a user's finger whilst holding the product 1. The push-button 17 is shown mounted to the end of a plunger 19 which extends into an internal housing of the pump 16 and which actuates the pump 16 when driven downwardly via operation of the push-button 17.

An inlet 20 of the pump 16 is shown connected to an inlet pipe 21, which may take the form of a length of flexible tubing. As will be appreciated, when the shroud 3 and its associated spray mechanism 15 are mounted to the container 2 in the manner illustrated in FIG. 1, the inlet pipe (“dip tube”) 21 will extend downwardly from the mechanism and will terminate with its open end 22 located at the bottom of the garment refreshing composition reservoir defined by the container 2. The inlet pipe 21 thus facilitates the draw-up of garment refreshing composition 12 from the reservoir upon operation of the spray mechanism 15.

The spray mechanism 15 also comprises a nozzle 23 which is fluidly connected to an outlet of the pump 16, and which is substantially completely enclosed within the shroud 3 so as to terminate at a discharge end 24 which located adjacent, and is substantially aligned with, the outlet aperture 4 of the shroud 3. A small discharge orifice 25 is formed in the nozzle 23 and is configured to direct an aerosol in the form of a fine mist of the garment refreshing composition 12 outwardly through the outlet aperture 4 in the spray direction 5, upon operation of the spray mechanism 15. As will be noted, the spray direction 5 is preferably substantially orthogonal to the respective longitudinal axes 8, 12 of the container 2 and the shroud 3, so as to be easily directed towards a fabric garment or the like by a user of the product 1.

In order to ensure the creation of an appropriately fine mist of the garment refreshing composition 12, the spray mechanism 15 may comprise an atomiser. As will be appreciated, in embodiments in which the garment refreshing composition 12 is provided as a liquid, the atomiser will be configured to break up a dose of the liquid drawn through the inlet tube 21, into a large number of small droplets and will thereby create the desired fine mist of the garment refreshing composition 12 for discharge from the product 1. It is envisaged that in some embodiments the atomiser will be provided as an integral feature of the nozzle 23. The atomiser may comprise a swirl chamber and/or a lateral dispersion chamber.

FIG. 4 illustrates a slightly modified version of the shroud 3 and associated spray mechanism 15 illustrated in FIG. 3. The version illustrated in FIG. 4 shares many aspects of the version illustrated in FIG. 3, and so identical or equivalent components are identified by the same reference numbers and will not be described in detail again. However, the alternative configuration illustrated in FIG. 4 does not have a spray mechanism actuator in the form of a push-button, but instead has an actuator in the form of a finger-operable trigger or lever 26. As will be noted, the trigger or lever 26 is mounted relative to the pump 16 via a pivotal connection 27, such that the trigger or lever is operable via pivotal movement to actuate the pump 16. The trigger or lever 26 protrudes from the spray mechanism 15, passes through an elongate slot 28 formed in the sidewall of the shroud 3 (and optionally below the outlet aperture 4), and terminates in a free end 29 which is spaced from the shroud 3. The slot 28 is sized so as to accommodate the pivotal range of movement of the trigger or lever 26 when actuated.

As will be appreciated, upon actuation of the pump 16, either via the push-button 17 in the case of the FIG. 3 arrangement, or via the trigger or lever 26 of the FIG. 4 arrangement, the pump 16 will draw a dose of the garment refreshing composition 12 from the reservoir, whereupon the atomiser will atomise the dose. The atomised dose will then be discharged through the discharge orifice 25 as an aerosol in the form of a fine mist 29, as illustrated in FIG. 5. As already indicated, the mist 29 will be discharged in a spray-direction 5 which is substantially orthogonal to the longitudinal axis 8 of the container 2.

It is considered advantageous for the discharge orifice 25 of the nozzle 23 to be configured to produce the fine mist 29 in a substantially circular cone pattern, and in a spray having a cone angle A in the range of 55 to 80 degrees. A spray pattern of this type has been found to provide very good coverage when the product 1 is used to spray the garment refreshing composition 12 onto a garment or the like, without the creation of localised areas of excessive wetness. More particularly, nozzle 23 and its associated atomiser may be configured in some embodiments to generate droplets within the mist 29 having an average diameter of in the range of 20 to 200 μm.

In some embodiments, it is envisaged that the spray mechanism 15 will be configured to draw a dose of the garment refreshing composition 12 having a volume of between 0.25 and 1.5 ml upon each actuation, for atomisation and discharge in the form of the fine mist 29. Accordingly, each spray of the fine mist 29 produced by the product 1 will thus contain between 0.25 and 1.5 ml of the garment refreshing composition. In other embodiments, the spray mechanism 15 may be configured to draw a dose of between 0.5 and 1.2 ml upon each actuation.

Average Droplet Size

Average droplet size and droplet size distribution is measured using a Malvern Spraytec particle and spray droplet size measurement device (ex Malvern Instruments Ltd, UK).

The size of spray droplets and spray particles are measured using laser diffraction. The intensity of light scattered as a laser beam passes through a spray is measured. This data is then analyzed by the measurement device to calculate the size of the droplets that created the scattering pattern. The spray device is positioned in the device holder so that the laser beam (1 cm diameter) crosses the centre of the spray plume about 15 cm from the nozzle discharge orifice.

Measurements are made for a period of 5 seconds while repeatedly firing (actuating) the spray. This process is repeated 3 times.

The average droplet size is taken to be the value of the peak/maximum of the plot of droplet diameter versus volume fraction. An example distribution plot is shown in FIG. 7.

Spray Cone Angle

Spray cone angle measurements are made by positioning a camera to the side of a spray device. The spray device is operated (e.g. the actuator is depressed) and an image is captured shortly after so as to record an image of the spray plume. The image is then analysed so as to identify the upper and lower boundaries of the spray plume and the image annotated with lines corresponding to these boundaries, the lines extending from the discharge orifice of the nozzle outwards along the boundaries. The cone angle is measured as the angle between the upper and lower lines, as shown in FIG. 5.

Regarding FIGS. 6A to 6C, a crease removal experiment was carried out to assess the effectiveness of a spray device configured to deliver a spray having the characteristics described herein.

The garment fabric sample was plain woven cotton washed with Persil Non-Bio. The sample was creased using an industry standard wrinkle recovery tester. The sample was dampened, put in the wrinkle tester with a 1 kg weight on top and left for 10 minutes. The sample was hung at 20° C./65% RH for 2-3 hours prior to imaging for ‘before’ level of creasing.

The sample was sprayed and 1 lb weight hung from bottom of fabric for 5 seconds. The sample was hung at 20° C./65% RH and re-imaged after 2 hours and after 24+ hours.

Imaging was carried out as follows, using the imaging apparatus illustrated schematically in FIG. 6A. The sample was placed flat in a box with side illumination. An image was taken from directly above the fabric. Creases show up in the image as highlights and shadows due to the side illumination. The level of creasing in the images was determined by on-screen sensory panel scoring.

Images are given a creasing score by comparison against a reference scale. The scales are created following extensive JND (Just Noticeable Difference) testing to determine significant differences and size of differences. Scores are on 0-10 continuous linear scale.

The garment refreshing composition comprised a silicone anti-wrinkle agent.

Significant crease removal was achieved, with creasing scores reduces by several integers.

FIG. 6C shows illustrative images acquired from samples before and after treatment.

Droplet Size

An example of droplet size measurement results is shown in FIG. 7. The data was acquired using a Malvern Spraytec instrument as discussed herein. The average droplet size is the peak maximum on the droplet diameter-volume fraction plot, in this case being about 75 μm.

Composition

A series of experiments were conducted to test whether the above mentioned droplet and cone angle characteristics could be achieved for a range of different garment refreshing compositions, including garment refreshing compositions having different viscosity/rheology behaviours.

The results of the tests showed that a range of viscosity/rheology behaviours could be accommodated whilst preserving “sprayability”.

When used in this specification and claims, the terms “comprises” and “comprising” and variations thereof mean that the specified features, steps or integers are included. The terms are not to be interpreted to exclude the presence of other features, steps or integers.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the scope of the invention.

1. A garment refresh product (1) comprising: a garment refreshing composition (12); and a hand-held spray device which is manually operable to produce a spray of said composition in the form of a fine aerosol (29); said composition (12) comprising at least one of: an anti-malodour agent, an anti-wrinkle agent, and a perfume; and said spray device comprising a reservoir (2) containing said composition (12) and a spray mechanism (15) housed within a shroud (3) which is substantially aligned with a longitudinal axis (8) of said reservoir (2); said spray mechanism (15) being manually operable to discharge a dose of said composition (12) from the product (1) in the form of a fine aerosol (29) and in a spray-direction (5) which is substantially orthogonal to said longitudinal axis (8) of the reservoir (2).

2. A garment refresh product according to claim 1, wherein said spray mechanism (15) comprises a nozzle (23) located within said shroud (3), the nozzle (23) having a discharge orifice (25) which is configured to produce said fine aerosol (29) in a spray having a cone angle (A) in the range of 55 to 80 degrees and/or a spray which comprises droplets having an average diameter in the range of 20 to 200 μm.

3. A garment refresh product (1) comprising: a garment refreshing composition (12); and a hand-held spray device which is manually operable to produce a spray of said composition (12) in the form of a fine aerosol (29); said composition (12) comprising at least one of: an anti-malodour agent, an anti-wrinkle agent, and a perfume; and said spray device comprising a reservoir (2) containing said composition (12) and a spray mechanism (15); said spray mechanism (15) comprising a nozzle (23) and being manually operable to discharge a dose of said composition (12) from the nozzle (23) in the form of a fine aerosol (29), wherein said nozzle is configured to produce said fine aerosol (29) in a spray having a cone angle (A) in the range of 55 to 80 degrees.

4. A garment refresh product according to claim 2, wherein said garment refreshing composition (12) is selected from (A) a garment refreshing composition comprising an anti-malodour agent, an anti-wrinkle agent, and a perfume; and (B) a garment refreshing composition comprising an anti-malodour agent, an anti-wrinkle agent, and an encapsulated perfume.

5. A garment refresh product according to claim 1, wherein said hand-held spray device is operable without the use of a pressurized propellant.

6. A garment refresh product according to claim 1, wherein said spray mechanism (15) comprises a hand-operable pump (16).

7. A garment refresh product according to claim 6, wherein said pump (16) is one of: a positive displacement pump; a self-priming pump; a reciprocating pump.

8. A garment refresh product according to claim 1, wherein said composition (12) is provided as a liquid and said spray mechanism (15) further comprises an atomiser configured to break up said liquid dose into droplets and thereby create said fine aerosol (29) in the form of a mist.

9. A garment refresh product according to claim 1, wherein said shroud (3) is substantially cylindrical in form and is mounted to said reservoir (2) so as to extend upwardly therefrom.

10. A garment refresh product according to claim 1, wherein said shroud (3) is removable, in combination with said spray mechanism (15) therein, from said reservoir (2).

11. A garment refresh product according to claim 10, wherein said shroud (3) and said reservoir (2) are configured for releasable engagement with one another.

12. A replacement reservoir (2) for a garment refresh product according to claim 10, the replacement reservoir (2) being pre-filled with a volume of said garment refreshing composition (12) for replenishment of said product (1), wherein the garment refreshing composition is selected from (A) a garment refreshing composition comprising an anti-malodour agent, an anti-wrinkle agent, and a perfume; and (B) a garment refreshing composition comprising an anti-malodour agent, an anti-wrinkle agent, and an encapsulated perfume.

13. A garment refresh spray comprising a fine mist (29) formed from a garment refreshing composition (12) comprising an anti-malodour agent and an anti-wrinkle agent, and an encapsulated or non-encapsulated perfume; wherein said spray has a cone angle (A) in the range of 55 to 80 degrees; and said mist (29) is formed from a dose of between 0.25 and 1.5 ml of said composition (12) and which comprises droplets having an average diameter in the range of 20 to 200 μm.

14. A garment refresh spray according to claim 13, wherein said mist (29) is formed from a dose of between 0.5 and 1.2 ml of said composition (12).

15. A method of creating a garment refresh spray according to claim 13, the method involving the provision and operation of a garment refresh product (1) comprising: a garment refreshing composition (12); and a hand-held spray device which is manually operable to produce a spray of said composition in the form of a fine aerosol (29); said composition (12) comprising at least one of: an anti-malodour agent, an anti-wrinkle agent, and a perfume; and said spray device comprising a reservoir (2) containing said composition (12) and a spray mechanism (15) housed within a shroud (3) which is substantially aligned with a longitudinal axis (8) of said reservoir (20); said spray mechanism (15) being manually operable to discharge a dose of said composition (12) from the product (1) in the form of a fine aerosol (29) and in a spray-direction (5) which is substantially orthogonal to said longitudinal axis (8) of the reservoir (2).
